(19) United States
(12) Patent Application Publication
(10) Pub. No.: US 2023/0342661 A1
(43) Pub. Date: Oct. 26, 2023

(54) MACHINE LEARNING BASED MONITORING FOCUS ENGINE

(71) Applicant: Microsoft Technology Licensing, LLC, Redmond, WA (US)

(72) Inventor: Kiran RAMA, Bangalore (IN)

(21) Appl. No.: 17/729,330

(22) Filed: Apr. 26, 2022

(51) Int. Cl. G06N 20/00

(52) U.S. Cl. CPC G06N 20/00

(57) ABSTRACT

A machine learning based monitoring focus engine is provided. Numeric and text features are collected from a computing system(s) and are utilized to determine if the system(s) will continue to run without issues or failures. That is, external characteristic information is received that corresponds to a predicted likelihood of a state that is associated with a processing system, and textual and numerical portions of the external characteristic information are mapped to neural network inputs. Word embedding is performed on the textual portion to generate embedded text features, and a plurality of inputs are provided to the neural network, where the plurality of inputs includes at least embedded text features, numerical features based on the numerical portion, and local features based on local characteristic information. Accordingly, the predicted likelihood of the state is determined based at least on an output of the neural network from the plurality of inputs.

### BACKGROUND

Custom rule-based heuristics and machine learning models are used to predict outcomes of particular scenarios based on building or training such models using specific training data for the scenarios being analyzed. In some solutions, simple classification models are trained and utilized to determine likelihoods of outcomes for particular scenarios with term document matrix formats for text features. Additionally, typical custom rule-based heuristics and machine learning models are built by those for which the particular scenarios are associated, and these solutions are singularly implemented. All current solutions are custom machine learning models written for a specific purpose.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Methods, systems, apparatuses, and computer-readable storage mediums described herein are configured for a machine learning based monitoring focus engine. Numeric and text features are collected from a computing system(s) such as different nodes in a cluster and are utilized to determine if the system(s) will continue to run without issues or failures. That is, external characteristic information is received that corresponds to a predicted likelihood of a state that is associated with a processing system, and a textual portion and a numerical portion of the external characteristic information are mapped to inputs of a neural network. Word embedding is performed on the textual portion to generate embedded text features, and a plurality of inputs are provided to the neural network, where the plurality of inputs includes at least embedded text features, numerical features based on the numerical portion, and local features based on local characteristic information. Accordingly, the predicted likelihood of the state is determined based at least on an output of the neural network from the plurality of inputs. In other words, a machine learning solution is described that allows any number of different users/customers of a machine learning based monitoring focus engine host, including internal host users/teams, to utilize the same extensible machine learning model for their determinations of predicted likelihoods, and the described solution provides for a data abstraction layer enabling users/customers to provide their own data, provides for a bring your own model layer enabling users/customers to provide their own machine learning model as an input, enables integration of local data already on the host platform as well as external data, and provides a new handling of text features as word embeddings into a Deep Neural Network (DNN) with an interpretability layer detailing incremental contributions to the predicted likelihood, as a unique application.

Further features and advantages, as well as the structure and operation of various example embodiments, are described in detail below with reference to the accompanying drawings. It is noted that the example implementations are not limited to the specific embodiments described herein. Such example embodiments are presented herein for illustrative purposes only. Additional implementations will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate example embodiments of the present application and, together with the description, further serve to explain the principles of the example embodiments and to enable a person skilled in the pertinent art to make and use the example embodiments.

FIG. 1 shows a block diagram of an example network-based computing system configured for a machine learning based monitoring focus engine, in accordance with an example embodiment.

FIG. 2 shows a flowchart of a method for a machine learning based monitoring focus engine, in accordance with an example embodiment.

FIG. 3 depicts a system flow diagram illustrating a sequence of actions performed with respect to a machine learning based monitoring focus engine, in accordance with an example embodiment.

FIG. 4 shows a flowchart of a method for a machine learning based monitoring focus engine, in accordance with an example embodiment.

FIG. 5 shows a flowchart of a method for a machine learning based monitoring focus engine, in accordance with an example embodiment.

FIG. 6 depicts a system flow diagram illustrating a sequence of actions performed with respect to a machine learning based monitoring focus engine, in accordance with an example embodiment.

FIG. 7 shows a flowchart of a method for a machine learning based monitoring focus engine, in accordance with an example embodiment.

FIG. 8 is a block diagram of an example processor-based computer system that may be used to implement various embodiments.

The features and advantages of the implementations described herein will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Introduction

The present specification and accompanying drawings disclose numerous example implementations. The scope of the present application is not limited to the disclosed implementations, but also encompasses combinations of the disclosed implementations, as well as modifications to the disclosed implementations. References in the specification to “one implementation,” “an implementation,” “an example embodiment,” “example implementation,” or the like, indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, or characteristic is described in connection with an implementation, it is submitted that it is within the knowledge of persons skilled in the relevant art(s) to implement such feature, structure, or characteristic in connection with other implementations whether or not explicitly described.

In the discussion, unless otherwise stated, adjectives such as “substantially” and “about” modifying a condition or relationship characteristic of a feature or features of an implementation of the disclosure, should be understood to mean that the condition or characteristic is defined to within tolerances that are acceptable for operation of the implementation for an application for which it is intended.

Furthermore, it should be understood that spatial descriptions (e.g., “above,” “below,” “up,” “left,” “right,” “down,” “top,” “bottom,” “vertical,” “horizontal,” etc.) used herein are for purposes of illustration only, and that practical implementations of the structures described herein can be spatially arranged in any orientation or manner.

If the performance of an operation is described herein as being “based on” one or more factors, it is to be understood that the performance of the operation may be based solely on such factor(s) or may be based on such factor(s) along with one or more additional factors. Thus, as used herein, the term “based on” should be understood to be equivalent to the term “based at least on.”

Numerous example embodiments are described as follows. It is noted that any section/subsection headings provided herein are not intended to be limiting. Implementations are described throughout this document, and any type of implementation may be included under any section/subsection. Furthermore, implementations disclosed in any section/subsection may be combined with any other implementations described in the same section/subsection and/or a different section/subsection in any manner.

### II. Example Implementations

Aspects described herein are directed to a machine learning (ML) based monitoring focus engine. For example, numeric and text features are collected from a computing system(s), such as different nodes in a cluster, and are utilized to determine, via a neural network such as a deep neural network (DNN), a predicted likelihood of a system state, such as if the system(s) will continue to run without issues or failures. According to various aspects, the machine learning based monitoring focus engine is configured to utilize local and external textual and numeric data, where textual data is word embedded prior to being input to the neural network, as well as external ML models as inputs to the neural network. Further, the various aspects provide for an interpretability layer by which incremental contributions of neural network variables to the predicted likelihood are determined and provided. Based on the outputs of the neural network, actions are enabled to be taken for the predicted state.

A monitoring focus engine (MFE) is an end-end state-of-the-art machine learning technique that is applicable to different types of systems, services, data, and/or the like. For example, one aspect of an MFE based on machine learning is an application running on-premise, while another aspect of such an MFE is an application running on the cloud (e.g., on top of Azure® from Microsoft Corp. or Redmond, WA, but could run on any cloud) that collects numeric and text features from different nodes in a server cluster and uses this information to determine if the load on the system will allow the cluster running without issue or failure.

Generally, the embodiments of MFEs herein utilize the following aspects: a data abstraction/mapping layer that allows a user to “bring your own data” (e.g., third-party or external data that is not considered when developing the MFE), the ability of the neural network in the MFE to incorporate any custom ML models of the user as features, the use of word embeddings for the text features that are input to the neural network, and the ability for the neural network to utilize a interpretability layer that provides explanations as to the incremental contributions of neural network variables toward the determined likelihood predictions for given states.

The data abstraction/mapping layer allows users to establish a data contract to determine the input pipelines into the MFE, and this applies to text, image, and numeric features, etc. For the server cluster load application example noted herein, this is the “bring-your-own-data” aspect for the user to map their specific cluster and node characteristics to the feature buckets utilized by the MFE application.

Accordingly, the manner of integration of the text and numeric features into a DNN, with an interpretability layer and embeddings for the text features, is a unique application of the described MFE and of embeddings to the problems of prior solutions which are dominated by traditional term-document matrices. That is, the MFE solutions provided herein are a combination of the data abstraction layer and ability to bring your own data and/or model, and the integration of text features as embeddings into a DNN, including a novel way to calculate the embedding size which performs more accurately and efficiently than traditional term-document matrices (e.g., by reducing memory and processing required for larger dimensionalities). Additionally, the integrated interpretability layer provides a focus on specific variables that impact states, and this enables specific actions to be taken for state predictions.

Existing solutions utilize simple rule-based heuristics and simple ML classification models that are customized to specific data to determine future states. In contrast, aspects herein provide a mapping layer that allows any user to map their own tools/data to the features that would work for this described MFE model, and allows the use of word embeddings enable a representation of the textual data that is multi-dimensional and richer than term-document matrix models while also avoiding memory footprint issues due to large dimensionality (e.g., the “curse of dimensionality” problem) inherent in other models, and also providing an interpretability layer for a DNN.

It should be noted herein that embodiments are generally directed to machine learning based monitoring focus engine, but that the MFE aspects described are applicable to different scenarios for state predictions that include, but are not limited to, uptime predictions for server clusters or other computing systems, predictions for states of automated components in different systems, predictions for states Therefore, even when embodiments herein exemplarily describe predictions of states for server clusters, such illustrative examples are not limiting, and aspects herein also contemplate other predicted likelihoods as noted herein, and also equivalent and/or analogous scenarios in which predicted likelihoods may be utilized, e.g., to take actions based thereon.

Accordingly, the aspects herein provide for solutions to issues associated with predictions of states via machine learning based monitoring focus engine, and further enable the ability to for different users to provide their own data and ML models to an adaptable MFE that is configured to map and incorporate their unique information. These and other aspects for machine learning based monitoring focus engines will be described in further detail herein in association with the Figures, and in the Sections/Subsections of description that follow below.

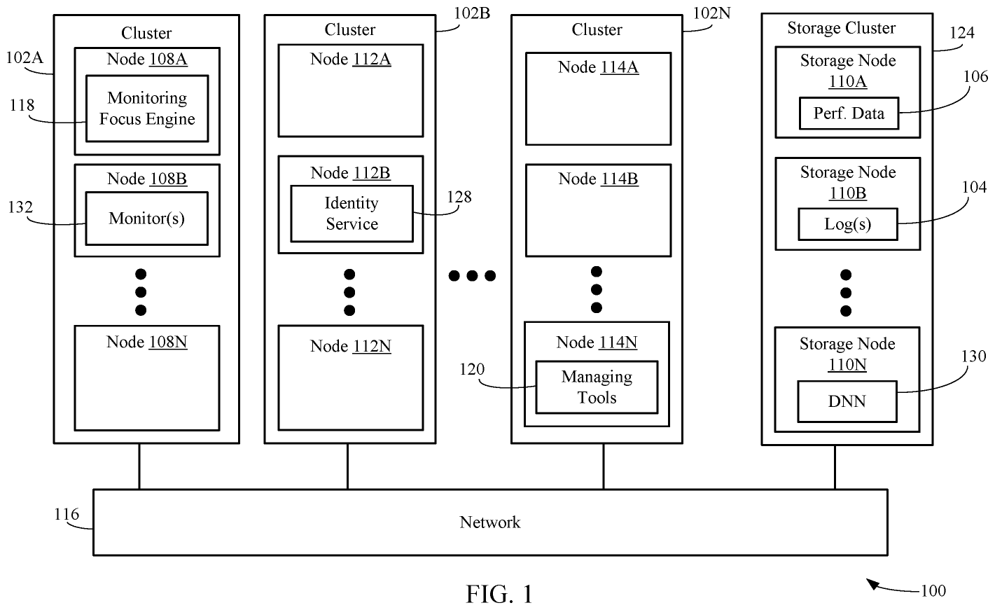

For example, FIG. 1 shows a block diagram of an example network-based computing system 100 configured for a machine learning based monitoring focus engine, according to an example embodiment. As shown in FIG. 1, system 100 includes a plurality of clusters 102A, 102B, and 102N and a storage cluster 124. Each of clusters 102A, 102B, and 102N, and storage cluster 124, are communicatively coupled to each other via network 116. Network 116 may comprise one or more networks such as local area networks (LANs), wide area networks (WANs), enterprise networks, the Internet, etc., and may include one or more of wired and/or wireless portions.

Clusters 102A, 102B and 102N and/or storage cluster 124 may form a network-accessible server set (e.g., a distributed or cloud-based environment or services platform (e.g., an environment/platform hosting types of resources, services, and/or applications)). Each of clusters 102A, 102B and 102N may comprise a group of one or more nodes (also referred to as compute nodes) and/or a group of one or more storage nodes. For example, as shown in FIG. 1, cluster 102A includes nodes 108A-108N, cluster 102B includes nodes 112A-112N, and cluster 102N includes nodes 114A-114N. Each of nodes 108A-108N, nodes 112A-112N, and/or nodes 114A-114N are accessible via network 116 (e.g., in a “cloud-based” embodiment) to build, deploy, and manage applications and services. Storage cluster 124 comprises one or more storage nodes 110A-110N. Each of storage node(s) 110A-110N comprises a plurality of physical storage disks that are accessible via network 116 and is configured to store data associated with the applications and services managed by nodes 108A-108N, nodes 112A-112N, and/or nodes 114A-114N.

As noted above, system 100 may include one or more distributed or “cloud-based” servers, in embodiments. That is, system 100 may be a network, or “cloud,” implementation for applications and/or services associated with hosting databases and/or data warehousing in a network architecture/cloud platform. A cloud platform includes a networked set of computing resources, including servers, routers, etc., that are configurable, shareable, provide data security, and are accessible over a network such as the Internet, according to embodiments. Cloud applications/services for hosting databases, data warehousing, and/or the like, are configured to run on these computing resources, often atop operating systems that run on the resources, for entities that access the applications/services, locally and/or over the network.

A cloud platform is configured to support multi-tenancy as noted above, where cloud platform-based software services multiple tenants, with each tenant including one or more users who share common access to certain software services and applications of the cloud platform, as noted herein. Furthermore, a cloud platform is configured to support hypervisors implemented as hardware, software, and/or firmware that run virtual machines (emulated computer systems, including operating systems) for tenants. A hypervisor presents a virtual operating platform for tenants in the cloud platform.

In an embodiment, one or more of cluster 102A, cluster 102B, and cluster 102N, and/or storage cluster 124, may be co-located (e.g., housed in one or more nearby buildings with associated components such as backup power supplies, redundant data communications, environmental controls, etc.) to form a datacenter, or may be arranged in other manners. Accordingly, in an embodiment, one or more of cluster 102A, cluster 102B, and cluster 102N, and/or storage cluster 124, may be a datacenter in a distributed collection of datacenters.

Each of node(s) 108A-108N, node(s) 112A-112N, and node(s) 114A-114N may comprise one or more server computers, server systems, and/or computing devices. Each of node(s) 108A-108N, node(s) 112A-112N, and node(s) 114A-114N may be configured to execute one or more software applications (or “applications”) and/or services and/or manage hardware resources (e.g., processors, memory, etc.), which may be utilized by users (e.g., customers or tenants in cloud-based platforms) of the network-accessible server set. Node(s) 108A-108N, node(s) 112A-112N, and node(s) 114A-114N may also be configured for specific uses. For example, as shown in FIG. 1, node 108A may be configured to execute a monitoring focus engine (MFE) 118, node 108B node may be configured to execute a monitor(s) 132, node 112B may be configured to execute an identity service 128, and node 114N may be configured to execute managing tools 120. It is noted that instances of MFE 118, monitor(s) 132, managing tools 120, and/or identity service 128 may be executing on other node(s) (e.g., node(s) 108B-108N, node(s) 112A-112N, and/or node(s) 114A-114N) in lieu of or in addition to the nodes respectively noted above. It is further noted that one or more of these components may be incorporated with each other.

Identity service 128 may be configured to maintain a plurality of user identities by which associated users may utilize to access one or more devices, applications, and/or services maintained by system 100 (e.g., web application and/or services hosted and/or executed by any of node(s) 108A-108N, node(s) 112A-112N, and/or node(s) 114A-114N) and/or associated with identity service 128. Likewise, identity service 128 may be configured to maintain a plurality of workload identities and associated credentials, which may be used for authentication and access. In response to a successful validation, the account/workload identity is provided access to the device, application, and/or service. An example of identity service 128 may include a directory, such as but without limitation, Microsoft® Azure Active Directory™ published by Microsoft Corp. of Redmond, WA. User data associated with their identity may be utilized herein as local data for input to the neural network of MFE 118, which may be stored in storage node 110N as a DNN 130.

Managing tools 120 may be configured to provide applications and/or services by which user data is collected. That is, managing tools 120 may monitor user accounts and utilized applications/services to collect data thereof, which may be utilized herein as local data for input to the neural network of MFE 118. Local data collected by managing tools 120 may by stored within system 100 at one or more storage nodes of storage cluster 124. It is also contemplated herein that external data, e.g., third party or user data, may be utilized as inputs for MFE 118 in various aspects.

Monitor(s) 132 is configured to monitor performance of servers, server clusters, nodes, etc. Monitor(s) 132 may detect and/or track characteristics and information such as, but not limited to, data bandwidth, latency, throughput, memory footprint/usage, processor usage, hard drive usage, utilization percentages for memory and/or processors, types of servers, central processing units (CPUs), and/or graphics processing units (GPUs), GPU load, numbers of running processes, and/or the like. Monitor(s) 132 may also be configured to monitor access to and/or actions taken with respect to applications, services, and/or data objects (e.g., managed by such applications and/or services). Additionally, monitor(s) 132 and/or each individual node may be collect/generate text log files 104 for the nodes illustrated in FIG. 1 that include state and operational information of the nodes, as would be understood by ones of skill in the relevant art(s) having the benefit of the instant disclosure. Monitor(s) 132 may be implemented at one or more clusters/nodes, including in each cluster/node of system 100. Text log files may be stored in a storage node, as exemplarily shown for storage node 110B, or elsewhere in different embodiments, and the detected characteristics and information may be stored as performance data 106, as exemplarily shown for storage 110a, or elsewhere in different embodiments.

In some aspects, text log files 104 and performance data 106 may be information and data that is external to system 100, e.g., is collected by a user and provided to MFE 118 for predictive analysis.

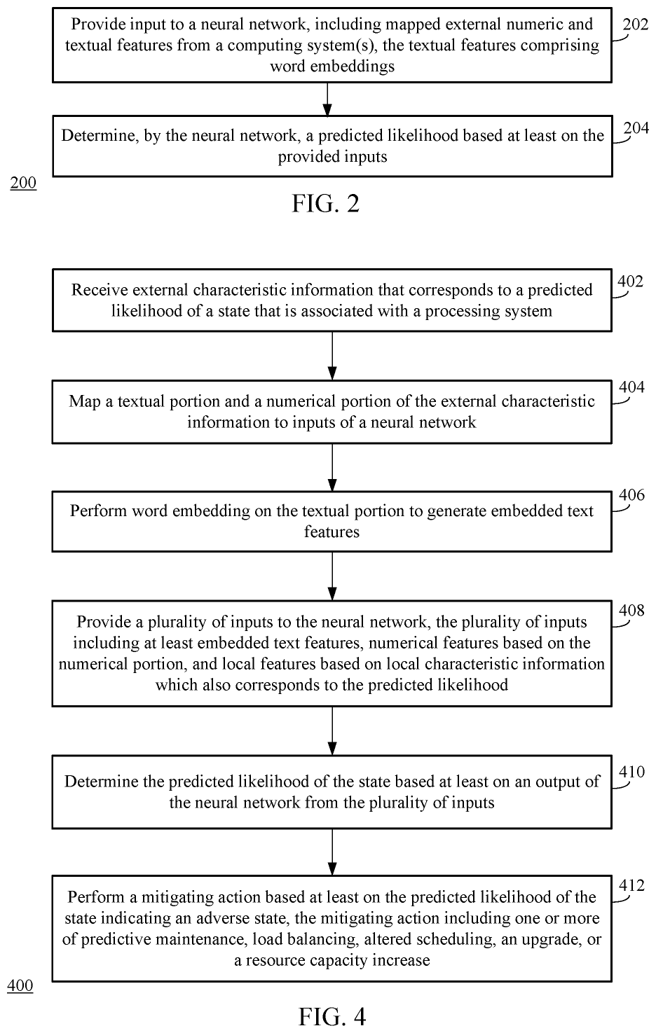

Referring now to FIG. 2, a flowchart 200 is shown for a method of a machine learning based monitoring focus engine, in accordance with an example embodiment. In various aspects, flowchart 200 is implemented by MFE 118 of system 100 shown in FIG. 1, although the method is not limited to that implementation. Accordingly, flowchart 200 will be exemplarily described with continued reference to FIG. 1. Other structural and operational embodiments will be apparent to persons skilled in the relevant art(s) based on the discussion regarding flowchart 200 and system 100 of FIG. 1.

Flowchart 200 begins with step 202. In step 202, input is provided to a neural network, including mapped external numeric and textual features from a computing system(s), the textual features comprising word embeddings. For example, text log files 104 and performance data 106, and external data/ML models in various aspects, may be provided to MFE 118 for input to a neural network thereof, e.g., DNN 130, where text of text log files 104 undergoes word embedding prior to neural network consumption, and external data features are mapped to DNN 130 such that the features can be utilized by DNN 130 (whereas otherwise they would not be).

In step 204, a predicted likelihood is determined by the neural network, based at least on the provided inputs. For instance, the neural network of MFE 118 is configured to determine a predicted likelihood based on the inputs in step 202, e.g., a predicted likelihood related to health or uptime for a server/server cluster.

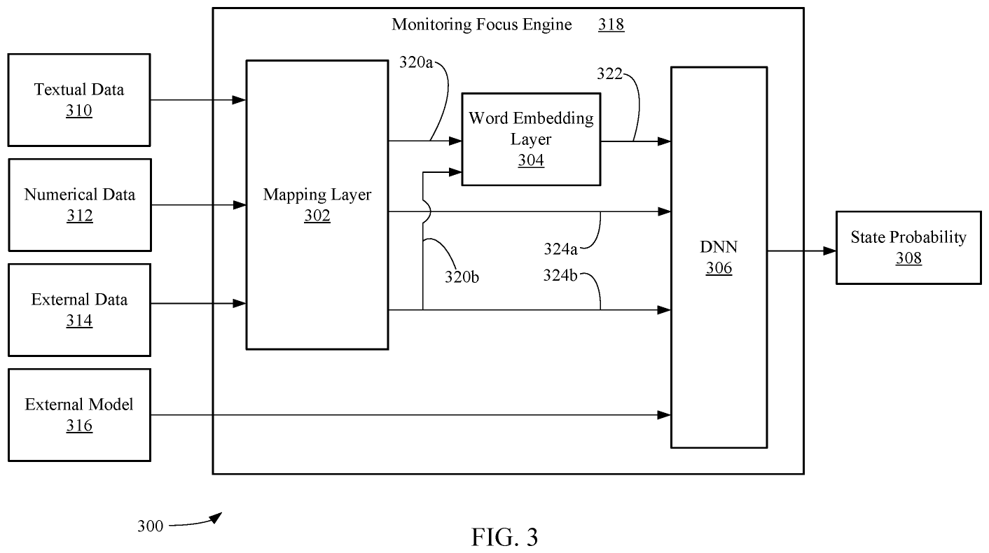

Further details regarding MFE 118 and flowchart 200 are provided below in reference to the described Figures. For example, FIGS. 3 and 4 will now be described in this context.

FIG. 3 depicts a system flow diagram 300 illustrating a sequence of actions performed with respect to a machine learning based monitoring focus engine, in accordance with an example embodiment. System flow diagram 300 is based on a monitoring focus engine (MFE) 318, which is an embodiment of MFE 118 of FIG. 1. FIG. 4 shows a flowchart 400 of a method for a machine learning based monitoring focus engine, in accordance with an example embodiment. In various aspects, flowchart 400 is implemented by MFE 318 of FIG. 3, although the method is not limited to that implementation. Accordingly, flowchart 400 will be exemplarily described with continued reference to FIGS. 1 and 3. Other structural and operational embodiments will be apparent to persons skilled in the relevant art(s) based on the discussion regarding system 100 of FIG. 1, system flow diagram 300, and flowchart 400.

As shown in system flow diagram 300, MFE 318 includes a mapping layer 302, a word embedding layer 304, and a deep neural network (DNN) 306 (which may be an embodiment of DNN 130 of FIG. 1). MFE 318 receives various inputs, described below, to generate an output as a state probability 308 that represents a predicted likelihood of the state.

MFE 318 is illustrated as receiving textual data 310, numerical data 312, and external data 314, which are taken in by mapping layer 302 and which represent characteristics, e.g., of a system for which a predicted likelihood is to be determined.

Referring also now to FIG. 4, flowchart 400 begins in step 402 in which local and external characteristic information that corresponds to a predicted likelihood of a state that is associated with a processing system is received. In the context of FIG. 3 and system flow diagram 300, textual data 310 may comprise text log data 104 of FIG. 1, in addition to other textual data, numerical data 312 may comprise performance data 106 of FIG. 1, in addition to other numerical data, and external data may comprise one or both of these data types which are provided by a user from outside of the system (i.e., the user brings their own data to MFE 318).

Mapping layer 302 is configured to map provided data and information to features that can be utilized by MFE 318. For instance, referring again to FIG. 4, in step 404, a textual portion and a numerical portion of the characteristic information are mapped to respective inputs of a neural network. Mapping layer 302 is configured to map textual portions 320a of textual data 310 (comprising a combined textual portion of data) and numerical portions 324a of numerical data 312 to inputs of DNN 306. Additionally, mapping layer 302 is configured to map textual portions 320b (comprising the combined textual portion of data) and numerical portions 324b of external data 314 to inputs of DNN 306. In other words, mapping layer 302 enables the mapping of available features of the user's external data to the features that will be used by the model.

Word embedding layer 304 is configured to perform word embeddings on textual portions of input data. For instance, referring again to FIG. 4, in step 406, word embedding is performed on the mapped textual portion to generate embedded text features. Word embedding layer 304 is configured receive mapped textual portions 320a and mapped textual portions 320b and to generate or derive embedded text features 322, according to aspects, which are a rich, multi-dimensional representation for the text inputs.

As noted above, the traditional way to represent the text features is using a term-document matrix (TDM), where each of the words is represented in a column. Traditional methods have all treated text using TDMs and are also known as “dummy” variables. A word embedding, in contrast and as utilized by aspects herein, will map m words to a n embedding where n<<m. This provides benefits over the prior TDM solutions. First, it reduces the dimensionality, helping avoid the “curse of dimensionality” problem that is a common pitfall in ML applications. Second, it helps learn a richer representation of the text inputs. That is, for a TDN model, each text term (e.g., word) is mapped to one column/feature, whereas in word embedding, each word is mapped to the entire embedding size, thereby learning a much richer representation.

Aspects herein also provide for the ability to input an external model 316 into DNN 306. That is, “bring your own model” capability allows the users/customers to bring in their own external ML models. In some aspects, such external ML models may be allowed as long as: their object or container types match DNN 306, they can be called with an application programming interface (API) endpoint when implementations call for such, and/or their time periods used for training and inference be the same, or substantially the same, as what is used for the model of DNN 306, so as to avoid any inadvertent leakage.

While not shown for illustrative clarity, MFE 318 may include a featurizer in various aspects that is configured to generate one or more feature vectors for input to DNN 306 based on textual data 310, numerical data 312, external data 314, and/or external model 316. Feature vectors generated by such a featurizer may take any form, such as a numerical, visual, and/or textual representation, or may comprise any other form suitable for representing audit the data. A featurizer may operate in a number of ways to featurize, or generate feature vectors for, a given set of data. For example, and without limitation, a featurizer may be configured to featurize a given set of data through time series analysis, keyword featurization, semantic-based featurization, digit count featurization, n-gram-TFIDF featurization, and/or the like.

DNN 306 is configured to receive a plurality of inputs and perform operations thereon. For instance, referring again to FIG. 4, in step 408, a plurality of inputs is provided to the neural network, the plurality of inputs including at least the embedded text features and numerical features based on the numerical portion. As shown in FIG. 3 and system flow diagram 300, DNN 306 of MFE 318 takes embedded text features 322, numerical portions 324a, and numerical portions 324b as inputs. Accordingly, DNN 306 is run on this these inputs and uses a target variable as the subsequent N-period, to the features creation point. The period may be in days, weeks, months, etc., or any other temporal window.

DNN 306 comprises one or more layers, in various aspects, where each layer in DNN 306 performs an affine transformation (W·X+b) followed by a non-linear operation ReLU, where

ReLU(x)=0 if x≤0 and x if x>0. (Equation 1)

It should be noted that W is the set of unknown weights that the DNN will seek to learn, X is the input, and b is the bias associated with the layer. The first layer of DNN 306 has the numeric features input as-is and the text features hitting the embedded text features. The embedded text features may be represented mathematically as Xₑ<<Xₜₑₓₜ. Thus, the word embedding is a compressed, high-dimensional representation of the input text. If X_{numeric} represents the numeric features the first layer to DNN 306 will be

W₁*(X_{numeric}+Wₑ(Xₜₑₓₜ)) (Equation 2)

after the affine transformation. It should be noted that this will be followed by a non-linear operator like the ReLU function.

Each subsequent layer performs the affine transformation and non-linear operation steps noted above. For example, in a scenario where DNN 306 includes three hidden layers, DNN 306 would compute the following form:

σ(W₃*(ReLU(W₂*(ReLU(W₁*(X_{numeric}+Wₑ(Xₜₑₓₜ))+b₁))+b₂)+b₃). (Equation 3)

DNN 306 is thus configured to generate state probability 308. For example, and referring again to FIG. 4, in step 410, the predicted likelihood of the state is determined based at least on an output of the neural network from the plurality of inputs. State probability 308 in FIG. 3 represents the predicted likelihood of the state that was to be determined by DNN 306.

Generating state probability 308 includes a number of sub-steps in various aspects. For instance, DNN 306 finds the unknown weights by a process of Stochastic Gradient Descent, including but without limitation, the following: initializing the unknowns to random values, where unknowns in the above equations are the weights (Wᵢ, where i is the layer and i=e implies an embedding in the first layer) and the biases (bᵢ, where i is the layer); computing the predicting value for the observation through the forward pass, which is described above, e.g., as noted for Equation 3; calculating the loss by comparing the output of the forward pass to the actual; back-propagating the loss through the layers; and repeating these sub-steps until convergence is achieved by DNN 306.

State probability 308 may indicate a prediction by DNN 306 that a state is likely or not likely. Referring back again to FIG. 4 and flowchart 400, in step 412, a mitigating action is performed based at least on the predicted likelihood of the state indicating an adverse state, the mitigating action including one or more of predictive maintenance, load balancing, altered scheduling, an upgrade, or a resource capacity increase. For instance, in the exemplary scenario of health/availability of a server or server cluster, state probability 308 may indicate that the server or server cluster is likely to be up and running after a period of time, or that the server may fail/crash, or have issues which impact/degrade performance, in such a time period. In cases where a failure or performance degradation is predicted, MFE 318 may trigger, or provide a communication to a system component to cause, a remedial action to be performed in an attempt to prevent the failure/degradation (e.g., by providing state probability 308 or indicia thereof to a system component that takes the remedial action).

Additionally, in some aspects, state probability 308 or indicia thereof may be provided to a user interface of a display via an alert, an email, a text message, etc., or to a predictive log file in some aspects, for an administrative user to be made aware of state probability 308. The administrative user is then enabled to take manual proactive steps and/or to provide support to a user whose system is predicted to be adversely impacted in the time period.

Thus, machine learning based monitoring focus engine aspects described herein improve system availability and operation at least by enabling proactive, predictive maintenance, load balancing and/or scheduling improvements, ease of hardware and software upgrades and determinations thereof, capacity increases for resources of systems, enable pro-active support, and/or the like. In this way, a user or an organization may be armed against a future failure event by having the machine learning based monitoring focus engine monitor the logs and performance features, and additionally external, user data, and accordingly taking proactive and preventive actions (either automatically or manually, e.g., based on alerts being provided).

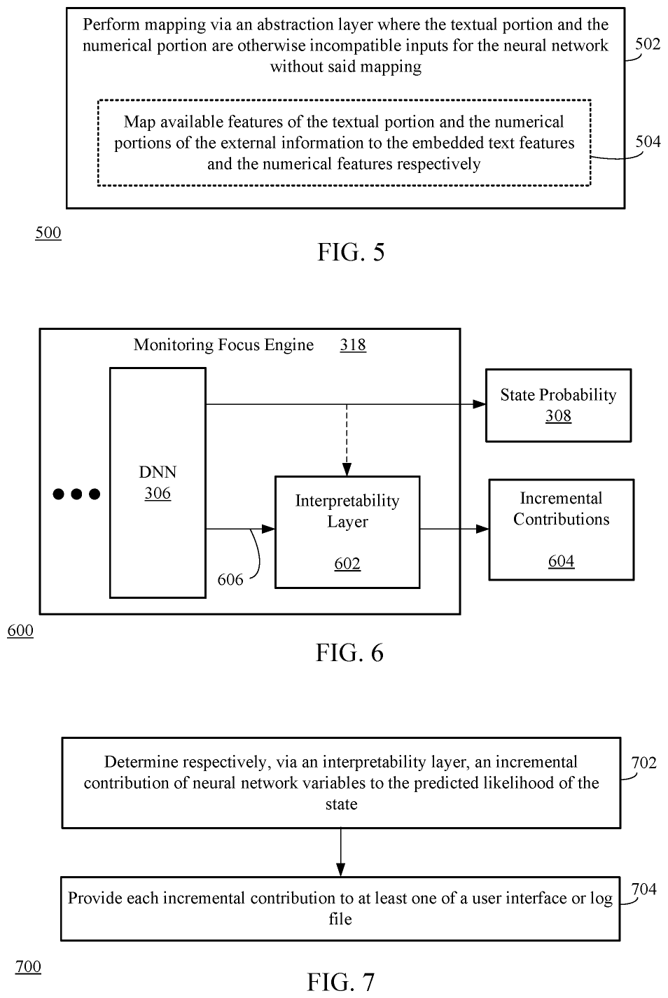

FIG. 5 shows a flowchart 500 of a method for a machine learning based monitoring focus engine, in accordance with an example embodiment. In various aspects, flowchart 500 is implemented by MFE 318 of FIG. 3, e.g., via mapping layer 302, although the method is not limited to that implementation. Accordingly, flowchart 500 will be exemplarily described with continued reference to FIGS. 1 and 3. Other structural and operational embodiments will be apparent to persons skilled in the relevant art(s) based on the discussion regarding system 100 of FIG. 1 and system flow diagram 300. Flowchart 500 is an embodiment of flowchart 400 of FIG. 4, in various aspects, such as of step 404.

In step 502, a mapping is performed via an abstraction layer where the textual portion and the numerical portion of the external information are otherwise incompatible inputs for the neural network without said mapping. Mappings herein are performed by mapping layer 302 of MFE 318 in FIG. 3, as described herein. According to step 502, mapping layer 302 is configured to utilize an abstraction layer in the mapping in order to link the external information to features that DNN 306 of FIG. 3 can accept. In other words, mapping layer 302 enables the mapping of available features of the user's external data to the features that will be used by the model to allow for the bring your own data aspects described herein.

Flowchart 500 may also include an additional sub-step 504 for step 502. In sub-step 504, available features of the textual portion and the numerical portion of the external information are mapped to the embedded text features and the numerical features respectively.

FIG. 6 and FIG. 7 will now be described with respect to an interpretability layer for a machine learning based monitoring focus engine. FIG. 6 depicts a system flow diagram 600 illustrating a sequence of actions performed with respect to a machine learning based monitoring focus engine, in accordance with an example embodiment. System flow diagram 600 is based on a portion monitoring focus engine (MFE) 318 of FIG. 3. FIG. 7 shows a flowchart 700 of a method for a machine learning based monitoring focus engine, in accordance with an example embodiment. In various aspects, flowchart 700 is implemented by MFE 318 of FIG. 3, although the method is not limited to that implementation. Accordingly, flowchart 700 will be exemplarily described with continued reference to FIGS. 1 and 3, and in the context of FIG. 6. Other structural and operational embodiments will be apparent to persons skilled in the relevant art(s) based on the discussion regarding the systems, flowcharts, and flow diagrams herein.

As illustrated, system flow diagram 600 includes DNN 306 and the output, state probability 308, as described above for FIG. 3. Also illustrated for system flow diagram 600 is an interpretability layer 602 and incremental contributions 604. DNN 306 may provide variable information 606 to interpretability layer 602. In some aspects, variable information 606 may include state probability 308.

Referring also to FIG. 7 and flowchart 700, in step 702, an incremental contribution of neural network variables to the predicted likelihood of the state is determined, respectively, via an interpretability layer. For example, interpretability layer 602 is configured to generate incremental contributions 604 of neural network variables to the predicted likelihood of the state. In aspects, incremental contributions 604 is/are based at least on variable information 606 where interpretability layer 602 determines incremental contributions 604 as outlines of the local importance as to why a particular predicted likelihood has a higher or lower score than a baseline predicted likelihood or another predicted likelihood.

In various aspects, MFE 318, as shown in FIG. 6, is configured to provide incremental contributions 604 for enhance decision making and/or remedial actions. Referring also to FIG. 7 and flowchart 700, in step 704, each incremental contribution is provided to at least one of a user interface or a prediction log file. For example, MFE 318 is configured to provide incremental contributions 604 and/or indicia thereof to a user interface or a prediction log file (not shown), in some aspects. The incremental contributions 604 and/or indicia thereof may be provided to a user interface of a display via an alert, an email, a text message, etc., or to a predictive log file in some aspects, for an administrative user to be made aware of the contribution that different neural network variables provide for the predictive likelihood output (e.g., state probability 308). The administrative user is then enabled to take manual proactive steps and/or to provide support to a user whose system is predicted to be adversely impacted by system characteristics linked to impactful variable values.

In some aspects, determining the local interpretability for neural network variables is performed by treating every prediction as a game that is played between the actors of the game (in this case feature values) and using a Shapley technique to determine the incremental contribution of each of the variables.

Accordingly, systems performing methods for a machine learning based monitoring focus engine may be implemented in many ways.

### III. Example Computer System Implementation

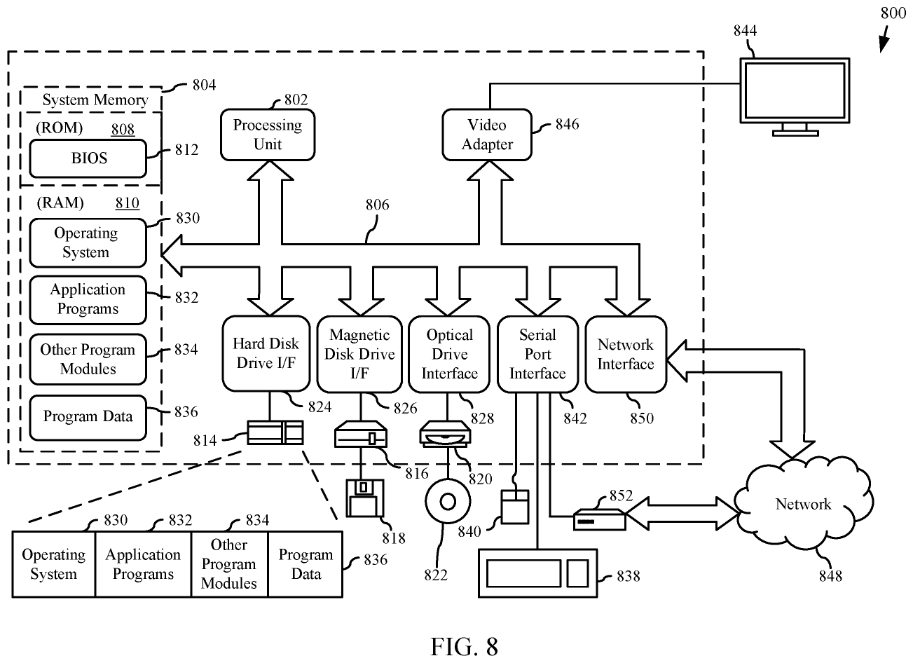

The systems and methods described above in reference to FIGS. 1-7, may be implemented in hardware, or hardware combined with one or both of software and/or firmware. For example, system 800 of FIG. 8 may be used to implement any of nodes 108A-108N, nodes 112A-112N, and/or nodes 114A-114N, storage node(s) 110A-110N, monitoring focus engine 118, monitor(s) 132, managing tools 120, and identity service 128 of FIG. 1, monitoring focus engine 318, mapping layer 302, embedding layer 304, a featurizer, and/or DNN 306 of FIG. 3, interpretability layer 602 of FIG. 6, along with any components and/or subcomponents thereof, as well as the flowcharts/flow diagrams described herein, including portions thereof, and/or further examples described herein, may be each implemented as computer program code/instructions configured to be executed in one or more processors and stored in a computer readable storage medium. Alternatively, any of nodes 108A-108N, nodes 112A-112N, and/or nodes 114A-114N, storage node(s) 110A-110N, monitoring focus engine 118, monitor(s) 132, managing tools 120, and identity service 128 of FIG. 1, monitoring focus engine 318, mapping layer 302, embedding layer 304, a featurizer, and/or DNN 306 of FIG. 3, interpretability layer 602 of FIG. 6, along with any components and/or subcomponents thereof, as well as the flowcharts/flow diagrams described herein, including portions thereof, and/or further examples described herein, may be implemented as hardware logic/electrical circuitry. In an embodiment, any of nodes 108A-108N, nodes 112A-112N, and/or nodes 114A-114N, storage node(s) 110A-110N, monitoring focus engine 118, monitor(s) 132, managing tools 120, and identity service 128 of FIG. 1, monitoring focus engine 318, mapping layer 302, embedding layer 304, a featurizer, and/or DNN 306 of FIG. 3, interpretability layer 602 of FIG. 6, along with any components and/or subcomponents thereof, as well as the flowcharts/flow diagrams described herein, including portions thereof, and/or further examples described herein, may be implemented in one or more SoCs (system on chip). An SoC may include an integrated circuit chip that includes one or more of a processor (e.g., a central processing unit (CPU), microcontroller, microprocessor, digital signal processor (DSP), etc.), memory, one or more communication interfaces, and/or further circuits, and may optionally execute received program code and/or include embedded firmware to perform functions.

FIG. 8 depicts an exemplary implementation of a computing device 800 in which embodiments may be implemented, including any of nodes 108A-108N, nodes 112A-112N, and/or nodes 114A-114N, storage node(s) 110A-110N, monitoring focus engine 118, monitor(s) 132, managing tools 120, and identity service 128 of FIG. 1, monitoring focus engine 318, mapping layer 302, embedding layer 304, a featurizer, and/or DNN 306 of FIG. 3, interpretability layer 602 of FIG. 6, along with any components and/or subcomponents thereof, as well as the flowcharts/flow diagrams described herein, including portions thereof, and/or further examples described herein. The description of computing device 800 provided herein is provided for purposes of illustration, and is not intended to be limiting. Embodiments may be implemented in further types of computer systems, as would be known to persons skilled in the relevant art(s).

As shown in FIG. 8, computing device 800 includes one or more processors, referred to as processor circuit 802, a system memory 804, and a bus 806 that couples various system components including system memory 804 to processor circuit 802. Processor circuit 802 is an electrical and/or optical circuit implemented in one or more physical hardware electrical circuit device elements and/or integrated circuit devices (semiconductor material chips or dies) as a central processing unit (CPU), a microcontroller, a microprocessor, and/or other physical hardware processor circuit. Processor circuit 802 may execute program code stored in a computer readable medium, such as program code of operating system 830, application programs 832, other programs 834, etc. Bus 806 represents one or more of any of several types of bus structures, including a memory bus or memory controller, a peripheral bus, an accelerated graphics port, and a processor or local bus using any of a variety of bus architectures. System memory 804 includes read only memory (ROM) 808 and random access memory (RAM) 810. A basic input/output system 812 (BIOS) is stored in ROM 808.

Computing device 800 also has one or more of the following drives: a hard disk drive 814 for reading from and writing to a hard disk, a magnetic disk drive 816 for reading from or writing to a removable magnetic disk 818, and an optical disk drive 820 for reading from or writing to a removable optical disk 822 such as a CD ROM, DVD ROM, or other optical media. Hard disk drive 814, magnetic disk drive 816, and optical disk drive 820 are connected to bus 806 by a hard disk drive interface 824, a magnetic disk drive interface 826, and an optical drive interface 828, respectively. The drives and their associated computer-readable media provide nonvolatile storage of computer-readable instructions, data structures, program modules and other data for the computer. Although a hard disk, a removable magnetic disk and a removable optical disk are described, other types of hardware-based computer-readable storage media can be used to store data, such as flash memory cards, digital video disks, RAMs, ROMs, and other hardware storage media.

A number of program modules may be stored on the hard disk, magnetic disk, optical disk, ROM, or RAM. These programs include operating system 830, one or more application programs 832, other programs 834, and program data 836. Application programs 832 or other programs 834 may include, for example, computer program logic (e.g., computer program code or instructions) for implementing the systems described above, including the embodiments described above with reference to FIGS. 1-7.

A user may enter commands and information into the computing device 800 through input devices such as keyboard 838 and pointing device 840. Other input devices (not shown) may include a microphone, joystick, game pad, satellite dish, scanner, a touch screen and/or touch pad, a voice recognition system to receive voice input, a gesture recognition system to receive gesture input, or the like. These and other input devices are often connected to processor circuit 802 through a serial port interface 842 that is coupled to bus 806, but may be connected by other interfaces, such as a parallel port, game port, or a universal serial bus (USB).

A display screen 844 is also connected to bus 806 via an interface, such as a video adapter 846. Display screen 844 may be external to, or incorporated in, computing device 800. Display screen 844 may display information, as well as being a user interface for receiving user commands and/or other information (e.g., by touch, finger gestures, a virtual keyboard, by providing a tap input (where a user lightly presses and quickly releases display screen 844), by providing a “touch-and-hold” input (where a user touches and holds his finger (or touch instrument) on display screen 844 for a predetermined period of time), by providing touch input that exceeds a predetermined pressure threshold, etc.). In addition to display screen 844, computing device 800 may include other peripheral output devices (not shown) such as speakers and printers.

Computing device 800 is connected to a network 848 (e.g., the Internet) through an adaptor or network interface 850, a modem 852, or other means for establishing communications over the network. Modem 852, which may be internal or external, may be connected to bus 806 via serial port interface 842, as shown in FIG. 8, or may be connected to bus 806 using another interface type, including a parallel interface.

As used herein, the terms “computer program medium,” “computer-readable medium,” “computer-readable storage medium,” and/or the like are used to generally refer to physical hardware media such as the hard disk associated with hard disk drive 814, removable magnetic disk 818, removable optical disk 822, other physical hardware media such as RAMs, ROMs, flash memory cards, digital video disks, zip disks, MEMs, nanotechnology-based storage devices, and further types of physical/tangible hardware storage media (including system memory 804 of FIG. 8). Such computer-readable media, computer-readable storage media, etc., are distinguished from and non-overlapping with communication media and propagating signals (do not include communication media and propagating signals). Communication media typically embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media, as well as wired media. Embodiments are also directed to such communication media that are separate and non-overlapping with embodiments directed to computer-readable storage media.

As noted above, computer programs and modules (including application programs 832 and other programs 834) may be stored on the hard disk, magnetic disk, optical disk, ROM, RAM, or other hardware storage medium. Such computer programs may also be received via network interface 850, serial port interface 852, or any other interface type. Such computer programs, when executed or loaded by an application, enable computing device 800 to implement features of embodiments discussed herein. Accordingly, such computer programs represent controllers of the computing device 800.

Embodiments are also directed to computer program products comprising computer code or instructions stored on any computer-readable medium. Such computer program products include hard disk drives, optical disk drives, memory device packages, portable memory sticks, memory cards, and other types of physical storage hardware.

### IV. Further Example Embodiments

As described, systems and devices embodying the techniques herein may be configured and enabled in various ways to perform their respective functions for a machine learning based monitoring focus engine. In embodiments, one or more of the steps or operations of any flowchart and/or flow diagram described herein may not be performed. Moreover, steps or operations in addition to or in lieu of those in any flowchart and/or flow diagram described herein may be performed. Further, in examples, one or more operations of any flowchart and/or flow diagram described herein may be performed out of order, in an alternate sequence, or partially (or completely) concurrently with each other or with other operations.

As described herein, systems, devices, components, etc., of the embodiments that are configured to perform functions and/or operations are also contemplated as performing such functions and/or operations.

Prior solutions fail to adequately address flexibility and richness of inputs in neural networks, and do not adequately provide for word embedding and interpretability in neural network predictions. Prior solutions instead focus on custom ML models for specific data and purposes that still rely on simple classification to achieve predictions that treat text features using term-document matrices. In contrast, the aspects herein utilize an extensible ML based monitoring focus engine that allows different users of cloud platforms, e.g., both internal users of a platform and its customers, to utilize a single solution that can map and accept different inputs, as well as including word embeddings for richer textual features balanced against dimensionality (which decreases memory footprint).

That is, the mapping/data abstraction layers for external data, the ability to input an external model, and the ability to integrate with local data of the user already on the cloud platform into a Deep Neural Network (DNN) with an interpretability layer has no analog in prior solutions. These and other improvements described herein for an extensible ML based monitoring focus engine were previously not available for software-based platforms and networks, much less for the specific system implementations, organizations, and architectures in the embodiments described herein.

Aspects herein are also applicable as features within a managing tool/software, e.g., Microsoft® Dynamics® or Dynamics 365® customer relationship management (CRM) tool (from Microsoft Corp., of Redmond, WA) to determine the likelihood of an opportunity to close, e.g., the state of the opportunity, again leveraging the text and numeric features. As noted herein, the data abstraction/mapping layer allows users to establish a data contract to determine the input pipelines into the MFE, and this applies to text, image, and numeric features, etc.

For the managing tool/software applications, this is the “bring-your-own-data” abstraction layer on top of an existing tool, e.g., Dynamics®, that allows any of the users/customers to run an opportunity-likely-to-close model that is an application on top of the base CRM tool. That is, users/customers are enabled to bring their own additional data on top of what is already available in the platform hosting the tool for their specific instance and still make use of the MFE model provided, as described herein.

The mapping layer that allows any user/organization that utilizes a CRM tool to map their own features, including text features as described herein. That is, text Features are not easily analyzed by each and every user/organization, e.g., owing to the lack of budget to hire data scientists and ML engineers. Some of these text features that are considered according to aspects herein include the free-form text in various fields, e.g., that the sellers use to include information about a sales opportunity. These include text information about budgets, competitor solutions, reasons why there is a high/low chance of closure, dissatisfaction, etc.

Additional features from opportunities are may also be included herein, e.g., sales information (order history, product purchase history, sales by product, etc.), firmographics (industry vertical, number of employees, etc.), marketing responses, clickstream/digital features, seller features, sales progression inputs, opportunity milestone fields in dynamics tool, third party datasets that are available in CRM tools, customer satisfaction (net promoter score) data, and/or the like.

Accordingly, desirable business outcomes such as the sales quadrants visualization as a 2×2 matrix of seller confidence against predicted likelihood (low-low, low-high, high-low, and high-high), likelihood of the opportunity win, inferences regarding the opportunity score, early deal quality assessments, and improved sales personnel allocation, which makes the predicted likelihood more viable and valuable for the users/customers. Sales quadrants visualization as a 2×2 includes four cases, as noted above. In cases where the model prediction likelihoods and the seller closure forecast are in agreement (high-high or low-low), then there is no action needed based on the agreement. Whereas, in cases where these are not in agreement (e.g., high predicted score and a low seller closure score, or vice-versa), then there is a need to probe the opportunity further for actions to take. For the likelihood of the opportunity win, more personnel can be allocated to the opportunities that are more likely to be closed.

The additional examples and embodiments described in this Section may be applicable to examples disclosed in any other Section or subsection of this disclosure.

Embodiments in this description provide for systems, devices, and methods for a machine learning based monitoring focus engine. For instance, such a system is described herein. The system includes at least one memory that stores program code, and a processing system, comprising one or more processors, configured to receive the program code from the memory and, in response to at least receiving the program code, to perform operations. The operations include to receive characteristic information, including local and external information, which corresponds to a predicted likelihood of a state that is associated with a processing system, and to map a textual portion and a numerical portion of the characteristic information to respective inputs of a neural network. The operations also include to perform word embedding on the mapped textual portion to generate embedded text features, provide a plurality of inputs to the neural network, the plurality of inputs including at least the embedded text features and numerical features based on the numerical portion, and determine the predicted likelihood of the state based at least on an output of the neural network from the plurality of inputs.

In an embodiment of the system, the processing system, in response to at least receiving the program code, is configured to perform a mitigating action based at least on the predicted likelihood of the state indicating an adverse state, the mitigating action including one or more of predictive maintenance, load balancing, altered scheduling, an upgrade, or a resource capacity increase.

In an embodiment of the system, at least one of the plurality of inputs to the neural network also includes an external machine learning model.

In an embodiment of the system, the embedded text has a reduced input dimensionality and has a mapping scope, via an embedding size, that is greater than the textual portion.

In an embodiment of the system, to map the textual portion and the numerical portion of the characteristic information to the inputs of the neural network includes mapping via an abstraction layer where the textual portion and the numerical portion are otherwise incompatible inputs for the neural network without said mapping.

In an embodiment of the system, the abstraction layer is configured to map available features of the textual portion and the numerical portion to the embedded text features and the numerical features respectively.

In an embodiment of the system, the processing system, in response to at least receiving the program code, is configured to: determine respectively, via an interpretability layer, an incremental contribution of neural network variables to the predicted likelihood of the state, and to provide each incremental contribution to at least one of a user interface or a prediction log file.

A method performed by a computing system is also described. The method includes receiving characteristic information, including local and external information, which corresponds to a predicted likelihood of a state that is associated with a processing system, and mapping a textual portion and a numerical portion of the external characteristic information to respective inputs of a neural network. The method also includes performing word embedding on the textual portion to generate embedded text features, providing a plurality of inputs to the neural network, the plurality of inputs including at least the embedded text features and numerical features based on the numerical portion, and determining the predicted likelihood of the state based at least on an output of the neural network from the plurality of inputs.

In an embodiment, the method further includes performing a mitigating action based at least on the predicted likelihood of the state indicating an adverse state, the mitigating action including one or more of predictive maintenance, load balancing, altered scheduling, an upgrade, or a resource capacity increase.

In an embodiment of the method, at least one of the plurality of inputs to the neural network also includes an external machine learning model.

In an embodiment of the method, the embedded text has a reduced input dimensionality and has a mapping scope, via an embedding size, that is greater than the textual portion.

In an embodiment of the method, to map the textual portion and the numerical portion of the characteristic information to the inputs of the neural network includes mapping via an abstraction layer where the textual portion and the numerical portion are otherwise incompatible inputs for the neural network without said mapping.

In an embodiment of the method, the abstraction layer is configured to map available features of the textual portion and the numerical portion to the embedded text features and the numerical features respectively.

In an embodiment, the method further includes determining respectively, via an interpretability layer, an incremental contribution of neural network variables to the predicted likelihood of the state, and providing each incremental contribution to at least one of a user interface or a prediction log file.

A computer-readable storage medium is also described. The computer-readable storage medium has program instructions recorded thereon that, when executed by at least one processor of a computing system, perform a method. The method includes receiving characteristic information, including local and external information, which corresponds to a predicted likelihood of a state that is associated with a processing system, and mapping a textual portion and a numerical portion of the external characteristic information to respective inputs of a neural network. The method also includes performing word embedding on the textual portion to generate embedded text features, providing a plurality of inputs to the neural network, the plurality of inputs including at least the embedded text features and numerical features based on the numerical portion, and determining the predicted likelihood of the state based at least on an output of the neural network from the plurality of inputs.

In an embodiment of the computer-readable storage medium, the method further includes at least one of: performing a mitigating action based at least on the predicted likelihood of the state indicating an adverse state, the mitigating action including one or more of predictive maintenance, load balancing, altered scheduling, an upgrade, or a resource capacity increase; or determining respectively, via an interpretability layer, an incremental contribution of neural network variables to the predicted likelihood of the state, and providing each incremental contribution to at least one of a user interface or a prediction log file.

In an embodiment of the computer-readable storage medium, at least one of the plurality of inputs to the neural network also includes an external machine learning model.

In an embodiment of the computer-readable storage medium, the embedded text has a reduced input dimensionality and has a mapping scope, via an embedding size, that is greater than the textual portion.

In an embodiment of the computer-readable storage medium, to map the textual portion and the numerical portion of the characteristic information to the inputs of the neural network includes mapping via an abstraction layer where the textual portion and the numerical portion are otherwise incompatible inputs for the neural network without said mapping.

In an embodiment of the computer-readable storage medium, the abstraction layer is configured to map available features of the textual portion and the numerical portion to the embedded text features and the numerical features respectively.

### V. Conclusion

While various example embodiments have been described above, it should be understood that they have been presented by way of example only, and not limitation. It will be understood by those skilled in the relevant art(s) that various changes in form and details may be made therein without departing from the spirit and scope of the embodiments as defined in the appended claims. Accordingly, the breadth and scope of the disclosure should not be limited by any of the above-described example embodiments, but should be defined only in accordance with the following claims and their equivalents.

What is claimed is:

1. A computing system, comprising:
at least one memory that stores program code; and
a processing system, comprising one or more processors, configured to receive the program code from the at least one memory and, in response to at least receiving the program code, to:
receive characteristic information, including local and external information, which corresponds to a predicted likelihood of a state that is associated with a processing system;
map a textual portion and a numerical portion of the characteristic information to respective inputs of a neural network;
perform word embedding on the mapped textual portion to generate embedded text features;
provide a plurality of inputs to the neural network, the plurality of inputs including at least the embedded text features and numerical features based on the numerical portion; and
determine the predicted likelihood of the state based at least on an output of the neural network from the plurality of inputs.

2. The computing system of claim 1, wherein the processing system, in response to at least receiving the program code, is configured to:
perform a mitigating action based at least on the predicted likelihood of the state indicating an adverse state, the mitigating action including one or more of predictive maintenance, load balancing, altered scheduling, an upgrade, or a resource capacity increase.

3. The computing system of claim 1, wherein at least one of the plurality of inputs to the neural network also includes an external machine learning model.

4. The computing system of claim 1, wherein the embedded text has a reduced input dimensionality and has a mapping scope, via an embedding size, that is greater than the textual portion.

5. The computing system of claim 1, wherein to map the textual portion and the numerical portion of the characteristic information to the inputs of the neural network includes mapping via an abstraction layer where the textual portion and the numerical portion are otherwise incompatible inputs for the neural network without said mapping.

6. The computing system of claim 5, wherein the abstraction layer is configured to map available features of the textual portion and the numerical portion to the embedded text features and the numerical features respectively.

7. The computing system of claim 1, wherein the processing system, in response to at least receiving the program code, is configured to:
determine respectively, via an interpretability layer, an incremental contribution of neural network variables to the predicted likelihood of the state; and
provide each incremental contribution to at least one of a user interface or a prediction log file.

8. A method performed by a computing system, the method comprising:
receiving characteristic information, including local and external information, which corresponds to a predicted likelihood of a state that is associated with a processing system;
mapping a textual portion and a numerical portion of the external characteristic information to respective inputs of a neural network;
performing word embedding on the textual portion to generate embedded text features;
providing a plurality of inputs to the neural network, the plurality of inputs including at least the embedded text features and numerical features based on the numerical portion; and
determining the predicted likelihood of the state based at least on an output of the neural network from the plurality of inputs.

9. The method of claim 8, further comprising:
performing a mitigating action based at least on the predicted likelihood of the state indicating an adverse state, the mitigating action including one or more of predictive maintenance, load balancing, altered scheduling, an upgrade, or a resource capacity increase.

10. The method of claim 8, wherein at least one of the plurality of inputs to the neural network also includes an external machine learning model.

11. The method of claim 8, wherein the embedded text has a reduced input dimensionality and has a mapping scope, via an embedding size, that is greater than the textual portion.

12. The method of claim 8, wherein to map the textual portion and the numerical portion of the characteristic information to the inputs of the neural network includes mapping via an abstraction layer where the textual portion and the numerical portion are otherwise incompatible inputs for the neural network without said mapping.

13. The method of claim 12, wherein the abstraction layer is configured to map available features of the textual portion and the numerical portion to the embedded text features and the numerical features respectively.

14. The method of claim 8, further comprising:
determining respectively, via an interpretability layer, an incremental contribution of neural network variables to the predicted likelihood of the state; and
providing each incremental contribution to at least one of a user interface or a prediction log file.

15. A computer-readable storage medium having program instructions recorded thereon that, when executed by at least one processor of a computing system, perform a method, the method comprising:
receiving characteristic information, including local and external information, which corresponds to a predicted likelihood of a state that is associated with a processing system;
mapping a textual portion and a numerical portion of the external characteristic information to respective inputs of a neural network;
performing word embedding on the textual portion to generate embedded text features;
providing a plurality of inputs to the neural network, the plurality of inputs including at least the embedded text features and numerical features based on the numerical portion; and
determining the predicted likelihood of the state based at least on an output of the neural network from the plurality of inputs.

16. The computer-readable storage medium of claim 15, wherein the method further comprises at least one of:
performing a mitigating action based at least on the predicted likelihood of the state indicating an adverse state, the mitigating action including one or more of predictive maintenance, load balancing, altered scheduling, an upgrade, or a resource capacity increase;
or
determining respectively, via an interpretability layer, an incremental contribution of neural network variables to the predicted likelihood of the state, and
providing each incremental contribution to at least one of a user interface or a prediction log file.

17. The computer-readable storage medium of claim 15, wherein at least one of the plurality of inputs to the neural network also includes an external machine learning model.

18. The computer-readable storage medium of claim 15, wherein the embedded text has a reduced input dimensionality and has a mapping scope, via an embedding size, that is greater than the textual portion.

19. The computer-readable storage medium of claim 15, wherein to map the textual portion and the numerical portion of the characteristic information to the inputs of the neural network includes mapping via an abstraction layer where the textual portion and the numerical portion are otherwise incompatible inputs for the neural network without said mapping.

20. The computer-readable storage medium of claim 19, wherein the abstraction layer is configured to map available features of the textual portion and the numerical portion to the embedded text features and the numerical features respectively.
